(19) United States
(12) Patent Application Publication
(10) Pub. No.: US 2011/0156636 A1
(43) Pub. Date: Jun. 30, 2011

(54) BATTERY PACK AND METHOD OF CONTROLLING CHARGING OF BATTERY PACK

(76) Inventor: Bong-Young Kim, Yongin-si (KR)

(21) Appl. No.: 12/954,460

(22) Filed: Nov. 24, 2010

(30) Foreign Application Priority Data
Dec. 28, 2009 (KR) 10-2009-0131801

(51) Int. Cl. H02J 7/00

(52) U.S. Cl. 320/108

(57) ABSTRACT

A battery pack and a method of controlling charging of the battery pack, the battery pack including a chargeable battery cell, a first charging circuit wirelessly charging the battery cell, a terminal part connecting the battery cell to an external device, a second charging circuit charging the battery cell by using power from an external power source connected to the terminal part, and a control circuit controlling charging performed by the first charging circuit and the second charging circuit, thereby allowing wireless and wired charging of the battery pack.

### CROSS-REFERENCE TO RELATED APPLICATION

This application claims the benefit of Korean Patent Application No. 10-2009-0131801, filed Dec. 28, 2009, in the Korean Intellectual Property Office, the disclosure of which is incorporated herein by reference.

### BACKGROUND

1. Field

Aspects of the present invention relate to a battery pack and a method of controlling charging of the battery pack.

2. Description of the Related Art

There has been increased use of portable electronic devices, such as mobile phones, digital cameras, notebook computers, and the like, and thus research into batteries supplying power to portable electronic devices has been actively conducted.

The batteries are in the form of a battery pack including a battery cell and a protection circuit controlling charging and discharging of the battery cell. The battery cells are categorized into lithium ion batteries, nickel-cadmium (Ni—Cd) batteries, and the like, according to the type of battery cells. These battery cells are rechargeable secondary batteries.

### SUMMARY

Aspects of the present invention include a wired and wireless chargeable battery pack and a method of controlling charging of the wired and wireless chargeable battery pack.

According to an aspect of the present invention, a battery pack includes: a chargeable battery cell; a first charging circuit wirelessly charging the battery cell; a terminal part connecting the battery cell to an external device; a second charging circuit charging the battery cell by using power from an external power source connected to the terminal part; and a control circuit controlling charging performed by the first charging circuit and the second charging circuit.

According to another aspect of the present invention, the battery cell may be simultaneously charged via the first charging circuit and the second charging circuit.

According to another aspect of the present invention, the first charging circuit may include a current inducing circuit generating a current induced by an external magnetic field; and a rectifier circuit rectifying the induced current.

According to another aspect of the present invention, the first charging circuit may include a diode preventing a reverse flow of current from the battery cell.

According to another aspect of the present invention, the first charging circuit may include a first control switch preventing over-charging of the battery cell.

According to another aspect of the present invention, the second charging circuit may include a second control switch controlling charging of the battery cell.

According to another aspect of the present invention, the control circuit may apply control signals to the first control switch and to the second control switch, wherein the control signals are the same.

According to another aspect of the present invention, the first charging circuit may induce a current from a signal having a frequency of 13.56 MHz.

According to another aspect of the present invention, an antenna installed in the external device may be shared with the first charging circuit.

According to aspects of the present invention, a method of controlling charging of a battery pack having a chargeable battery cell and a terminal part connected in parallel to the battery cell includes: wirelessly charging the battery cell by using power induced by an external magnetic field; and charging the battery cell via a wired connection by using an external power source applied to the terminal part.

According to another aspect of the present invention, the wireless charging and the wired charging may be simultaneously performed.

According to another aspect of the present invention, when only the wired charging is performed, a reverse flow of current from the battery cell to an element for the wireless charging may be prevented.

According to another aspect of the present invention, when the battery cell is over-charged, the wired charging and the wireless charging of the battery cell may be simultaneously terminated.

According to another aspect of the present invention, the wireless charging of the battery cell may include: inducing a current via an external magnetic field, rectifying the induced current, and charging the battery cell by using the rectified current.

According to another aspect of the present invention, in the wireless charging of the battery cell, a signal having a frequency of 13.56 MHz may be used.

According to aspects of the present invention, a method of charging a battery pack having a rechargeable battery cell, a wireless charger, a wired charger and a terminal part connected in parallel to the battery cell includes: determining whether the wired charger is connected to the battery pack; determining whether the wireless charger is connected to the battery pack; charging the battery cell of the battery pack according to the determining whether the wired charger is connected to the battery pack and the determining whether the wireless charging is connected to the battery pack; determining whether the battery cell of the battery pack is fully charged; and terminating the charging upon the determining that the battery pack is fully charged.

According to another aspect of the present invention, the charging of the battery cell may include charging the battery cell using the wired charger and the wireless charger simultaneously if it is determined that the wired charger and the wireless charger are connected to the battery pack.

According to another aspect of the present invention, the charging of the battery cell may include: charging the battery cell using only the wired charger if it is determined that only the wired charger is connected to the battery pack; and blocking a reverse flow of current from the battery cell to an element for the wireless charging.

According to another aspect of the present invention, the charging of the battery cell may include charging the battery cell using only the wireless charger if it is determined that only the wireless charger is connected to the battery pack.

According to another aspect of the present invention, if the charging of the battery cell includes a wireless charging of the battery cell using the wireless charger, the wireless charging may include: inducing a current via an external magnetic field; rectifying the induced current; and charging the battery cell by using the rectified current.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of a battery pack according to an embodiment of the present invention;

FIG. 2 is a circuit diagram of the battery pack of FIG. 1, according to an embodiment of the present invention;

FIG. 3 is a circuit diagram of the battery pack of FIG. 1, according to another embodiment of the present invention;

FIG. 4 is a flowchart illustrating a method of controlling charging of a battery pack, according to an embodiment of the present invention; and

FIG. 5 is a concept view illustrating charging of the battery pack of FIG. 1.

### DETAILED DESCRIPTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

It will be understood that, although the terms first, second, third, etc., may be used herein to describe various elements, components, regions, and/or sections, these elements, components, regions, and/or sections should not be limited by these terms. These terms are only used to distinguish one element, component, region or section from another element, component, region or section. Thus, a first element, component, region or section discussed below could be termed a second element, component, region or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

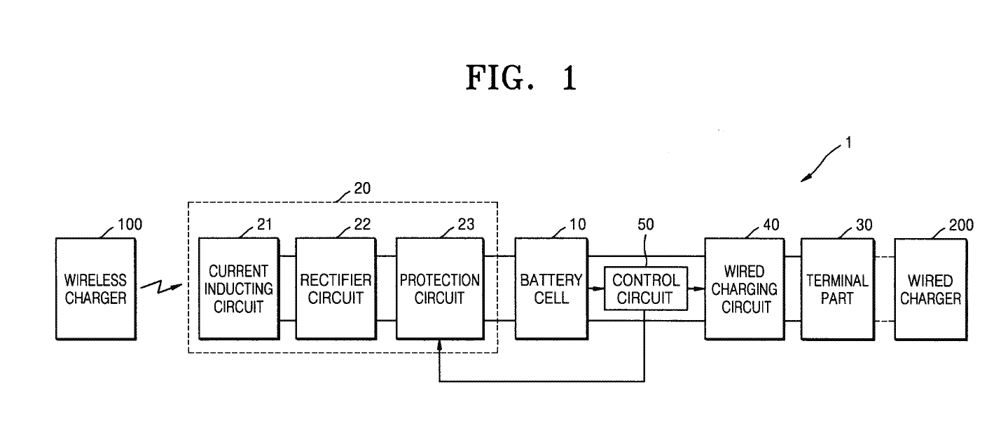

FIG. 1 is a block diagram of a battery pack 1 according to an embodiment of the present invention. Referring to FIG. 1, the battery pack 1 includes a battery cell 10, a wireless charging circuit 20, a terminal part 30, a wired charging circuit 40, and a control circuit 50.

The battery cell 10 includes at least one bare cell (not shown). When the battery cell 10 is connected to an external device, which includes the wired charger 200, via the terminal part 30, the battery cell 10 is charged or discharged. Although not shown, the bare cell includes an electrode assembly including a positive electrode plate, a negative electrode plate, and a separator, a can accommodating the electrode assembly therein and having a top opening, and a cap assembly covering the top opening of the can to seal the can. The battery cell 10 is a rechargeable secondary battery. However, aspects of the present invention are not limited thereto, and the battery cell 10 may be any suitable type of secondary battery.

The wireless charging circuit 20 is not physically connected to the terminal part 30 of the battery pack 1, and enables wireless charging of the battery cell 10 by using an external power source (not shown). A wireless charging method of the battery cell 10 is similar to a principle of wireless communication. In other words, a signal transmitted by an external device is received in a coil of an antenna included in the wireless charging circuit 20, and a current induced by the received signal is used to perform wireless charging of the battery cell 10. To conduct wireless charging, the wireless charging circuit 20 includes a current inducing circuit 21, a rectifier circuit 22, and a protection circuit 23. However, aspects of the present invention are not limited thereto and the wireless charging circuit may include other suitable elements.

The current inducing circuit 21 detects a change in a magnetic field formed outside of the battery pack 1 to generate an induction current in the battery pack 1. In particular, a wireless charger 100 forms a magnetic field by using a high-frequency current to wireless charge the battery pack 1. The magnetic field formed outside of the battery pack 1 is converted back to the high frequency current by the current inducing circuit 21. In other words, the current inducing circuit 21 is electrically coupled with the wireless charger 100 by inductive coupling. The induction current generated by the current inducing circuit 21 is an alternating current (AC current) having a magnitude and phase that vary with time. In this regard, in order to efficiently charge the battery cell 10, power that is supplied to the current inducing circuit 21 from the wireless charger 100 and then induced by the current inducing circuit 21 may be 4 watt-hours (Wh) or greater.

The rectifier circuit 22 rectifies the current induced by the current inducing circuit 21. In other words, the rectifier circuit 22 converts the AC current to a direct current (DC current), and a magnitude of the DC current remains constant. The rectifier circuit 22 includes a coil inductively coupling with the wireless charger 100 and a smoothing circuit maintaining the magnitude of the DC current.

The protection circuit 23 protects the wireless charging circuit 20 and the battery cell 10 when the wireless charging circuit 20 malfunctions and breaks down. The protection circuit 23 allows or interrupts a current applied to the battery cell 10 from the current inducing circuit 21 and the rectifier circuit 22, and includes various kinds of elements to perform this operation. For example, when the battery cell 10 is overcharged, the protection circuit 23 blocks a charging path from the wireless charging circuit 20 to the battery cell 10 to protect the battery cell 10 from overcharging. In addition, the protection circuit 23 interrupts a current flowing to the wireless charging circuit 20 from the battery cell 10. For example, while the battery cell 10 is charged by a wired charger 200, voltage across the battery cell 10 may be higher than voltage across the wireless charging circuit 20, and thus a current leaks from the battery cell 10 to the wireless charging circuit 20. In this regard, the protection circuit 23 prevents a reverse flow of current. The control circuit 50, which will be described later, controls the protection circuit 23. However, aspects of the present invention are not limited thereto and other suitable circuits may control the protection circuit 23.

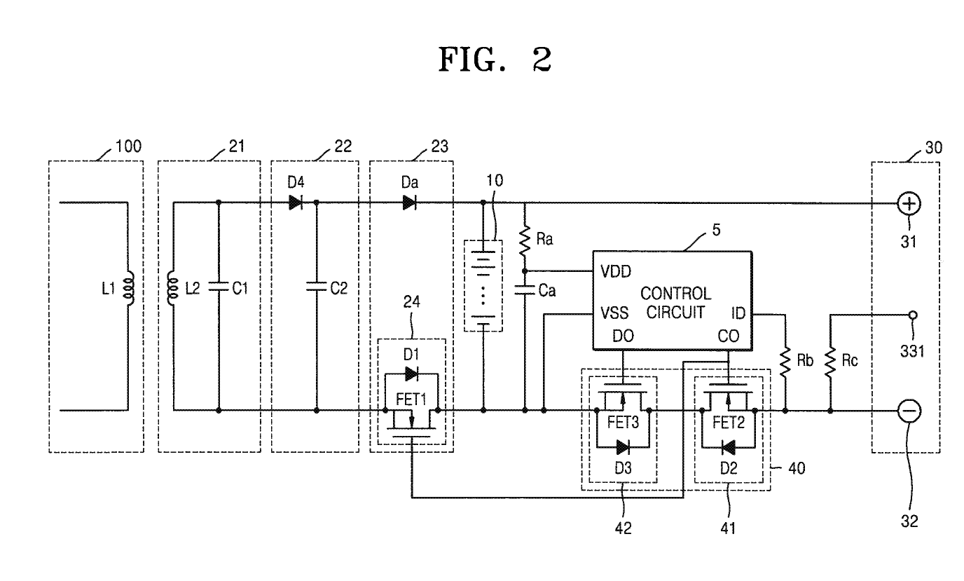

The terminal part 30 is connected to an external device, such as an electronic device or the wired charger 200. The terminal part 30 includes a positive electrode terminal 31 (see FIG. 2) and a negative electrode terminal 32 (see FIG. 2). The terminal part 30 is connected in parallel to the battery cell 10, and when connected to the external device, such as the wired charger 200), performs charging or discharging of the battery cell 10. A path between the terminal part 30 and the battery cell 10 is a large current path used as a charging and discharging path, and a large current may flow via the large current path.

The wired charging circuit 40 is a circuit used to charge the battery cell 10 by using power supplied to the wired charging circuit 40 via the terminal part 30. The battery cell 10 is charged using a current flowing via the large current path through the terminal part 30, the wired charging circuit 40, and the battery cell 10. The wired charging circuit 40 also acts as a discharging circuit when the terminal part 30 is connected to the external device, such as an electronic device. Although not shown in FIG. 1, the wired charging circuit 40 includes a charging control element controlling charging of the battery cell 10 and a discharging control element controlling discharging of the battery cell 10.

The wireless charging circuit 20 and the wired charging circuit 40 operate independently, and thus only wireless charging of the battery cell 10 is performed by using the wireless charging circuit 20, or only wired charging of the battery cell 10 is performed by using the wired charging circuit 40. However aspects of the present invention are not limited thereto, and since the battery pack 1 includes both the wireless charging circuit 20 and the wired charging circuit 40, wireless and wired charging are simultaneously performable. In this case, an amount of current supplied to the battery cell 10 is increased, thereby allowing a more rapid charging of the battery cell 10.

The control circuit 50 controls internal operations of the battery pack 1 to stably operate the battery pack 1. In particular, the control circuit 50 controls the wireless charging circuit 20 and the wired charging circuit 40 in order to charge the battery cell 10. In other words, the control circuit 50 controls the wireless charging circuit 20 and the wired charging circuit 40 so that each performs charging of the battery cell 10 when the control circuit 50 detects that at least one of the wireless charger 100 and the wired charger 200 is connected to the battery pack 1. For example, a control switch included in the wireless charging circuit 20 or the wired charging circuit 40 is switched on during charging of the battery cell 10 to form the large current path.

In addition, when the battery cell 10 is overcharged or it is detected that the battery pack 1 is malfunctioning during charging of the battery cell 10, the control switch is switched off to block the large current path. In this regard, the control circuit 50 controls the wireless charging circuit 20 and the wired charging circuit 40 by using a same control signal.

However, aspects of the present invention are not limited thereto, and the control circuit 50 may use other suitable methods to control the wireless charging circuit 20 and the wired charging circuit 40. For example, the control circuit 50 may control the wireless charging circuit 20 and the wired charging circuit 40 by using different control signals.

Besides the control operation of the control circuit 50 described above, the control circuit 50 detects a voltage of the battery cell 10 in order to determine whether the battery cell 10 is overcharged, and also detects states of the bare cells included in the battery cell 10 in order to perform cell balancing. In addition, the control circuit 50 determines whether an over-current flows or measures a temperature of the battery pack 1 to control charging and discharging of the battery cell 10.

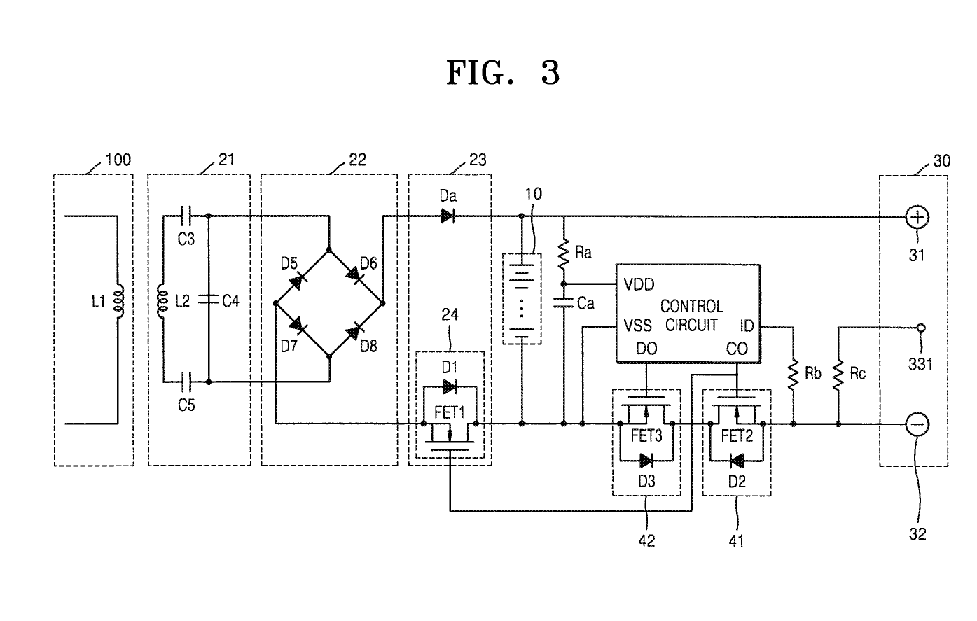

A configuration of the battery pack 1 will now be described in more detail with reference to FIGS. 2 and 3. FIG. 2 is a circuit diagram of the battery pack 1 of FIG. 1, according to an embodiment of the present invention.

The wireless charging circuit 20 includes a coil L2 and a capacitor C1 as the current inducing circuit 21. The coil L2 is inductively coupled to a coil L1 included in the wireless charger 100, and detects a change in a magnetic field generated when an AC current is supplied to the coil L1 in order to generate an induction current. The capacitor C1 is connected in parallel to the coil L2 and allows an alternating current generated by the coil L2 to resonate at a predetermined frequency. The inductance of the coil L2 and the capacitance of the capacitor C1 may be such as to satisfy the following equation:

$$f = \frac{1}{2 π \sqrt{LC}} .$$

In the equation, f denotes a resonance frequency, which is a frequency of the AC current used in wireless charging. In the present embodiment, a frequency of 13.56 MHz, which is used in RFID technology, is used. However, aspects of the present invention are not limited thereto, and other suitable frequencies may be used. In addition, the coil L2 may be an antenna, and an antenna installed in the electronic device connected to the battery pack 1 may be used as the coil L2. For example, an antenna having a resonant frequency of 13.56 MHz, which is the frequency used to carry out E-commerce operations in mobile phones, is commonly used. However, aspects of the present invention are not limited thereto, and other suitable frequencies may be used.

Although not illustrated in FIGS. 2 and 3, a shielding element may be disposed on a rear surface of the battery cell 10 to increase an efficiency of power induction in the coil L2. In other words, the shielding element may be disposed between the coil L2 and the battery cell 10. For example, when an antenna for communication of an electronic device is used as the coil L2, the shielding element may be disposed on a portion of the battery pack 1 that contacts the electronic device.

A rectifier circuit 22 of the wireless charging circuit 20 is a smoothing circuit and includes a diode D4 and a capacitor C2. An anode of the diode D4 is connected to a first terminal of the coil L2, and a cathode of the diode D4 is connected to the protection circuit 23. In addition, the capacitor C2 allows current supplied by the diode D4 to remain constant. One terminal of the capacitor C2 is connected to the cathode of the diode D4, and another terminal of the capacitor C2 is connected between a second terminal of the coil L2 and the protection circuit 23.

The protection circuit 23 of the wireless charging circuit 20 includes a diode Da preventing a reverse flow of current and a control switch 24 to control wireless charging. The diode Da prevents a reverse flow of current from the battery cell 10 to the wireless charging circuit 20. In other words, a leakage of current, while wired charging of the battery cell 10 is performed using the wired charger 100 is prevented by the diode Da. In addition, the diode Da may prevent a leakage of current from the battery cell 10 to the wireless charging circuit 20 when the battery cell 10 is discharged by an external device, such as an electronic device.

The control switch 24 controlling wireless charging includes a field effect transistor (FET) FET1 and a diode D1. When the battery cell 10 is being charged, the control switch 24 is in an on-state and the control switch 24 forms a path to charge the battery pack 1. Thus, a drain electrode of the FET1 is connected to a negative electrode of the battery cell 10, and a source electrode of the FET1 is connected to the second terminal of the coil L2. In this regard, the FET1 of the control switch 24 is a switching device. However, aspects of the present invention are not limited thereto and the control switch 24 may also include any of other kinds of electric devices that may act as a switching device.

The terminal part 30 includes the positive electrode terminal 31 and the negative electrode terminal 32. When the positive electrode terminal 31 and the negative electrode terminal 32 are connected to the electronic device, the battery cell 10 is discharged, on the other hand, when the positive electrode terminal 31 and the negative electrode terminal 32 are connected to the wired charger 200, wired charging of the battery cell 10 is performed. In this regard, the negative electrode terminal 32 is connected to a capacitance-detecting resistor Rc that represents the capacitance of the battery cell 110. Terminal 331 of the capacitance-detecting resistor Rc is connected to an external device, such as the electronic device, and the external device detects a resistance value of the capacitance-detecting resistor Rc in order to determine the capacitance of the battery cell 10.

The wired charging circuit 40 includes a charging control switch 41 and a discharging control switch 42. The charging control switch 41 includes an FET2 and a diode D2, and the discharging control switch 42 includes an FET3 and a diode D3. A connection direction between a source and a drain of the FET2 of the charging control switch 41 is set reversely to that of a connection direction of a source and a drain of the transistor FET3 of the discharging control switch 42. In particular, the FET2 of the charging control switch 41 is connected so as to restrict a current flowing from the battery cell 10 towards the terminal part 30. The FET3 of the discharging control switch 42 is connected so as to restrict a current flowing from the terminal part 30 towards the battery cell 10. In this regard, the FET2 of the charging control switch 41 and the FET3 of the discharging control switch 42 are field effect transistor switching devices. However, aspects of the present invention are not limited thereto, and the charging control switch 41 and the discharging control switch 42 may be any of other kinds of electric devices that may act as a switching device. In addition, the diode D2 of the charging control switch 41 and the diode D3 of the discharging control switch 42 are connected in directions in which currents are restricted by the FET2 and the FET3, respectively.

A control circuit 50 includes a plurality of input terminals and a plurality of output terminals. The control switch 50 controls the wireless charging circuit 20 and the wired charging circuit 40 according to voltage or current values applied to the input terminals. In particular, the control circuit 50 includes VDD, VSS and ID terminals as the input terminals. The VDD terminal is connected to a terminal between a capacitor Ca and a resistor Ra, which are connected in series between the positive and negative electrodes of the battery cell 10. The control circuit 50 detects the voltage of the battery cell 10 via the VDD terminal to determine whether the battery cell 10 is in a charging or discharging state. The VSS terminal is connected to the negative electrode of the battery cell 10, and the control circuit 50 uses a voltage of the negative electrode of the battery cell 10 as a ground voltage. A resistor Rb is connected between the ID terminal and the negative electrode terminal 32, and the control circuit 50 detects whether an over-current flows in the battery pack 1.

When the control circuit 50 detects that the wireless charger 100 and/or the wired charged 200 is connected to the battery pack 1, the control circuit 50 applies a high-level control signal to the charging control switch 41 via a CO terminal. The charging control switch 41 is switched on by the control signal output by the CO terminal, and charging of the battery cell 10 is performable, accordingly. When the control circuit 50 determines that the battery cell 10 is overcharged, the control circuit 50 outputs a low-level control signal via the CO terminal, and thus charging of the battery cell 10 is terminated. On the other hand, when the control circuit 50 detects that the terminal part 30 is connected to the electronic device, the control circuit 50 applies a high-level control signal to the discharging control switch 42 via a DO terminal. The discharging control switch 42 is switched on by the control signal output by the DO terminal, and discharging of the battery cell 10 is performable, accordingly. When the control circuit 50 determines that the battery cell 10 is over-discharged, the control circuit 50 outputs a low-level control signal via the DO terminal, and discharging of the battery cell 10 is terminated, accordingly.

The control signal output by the CO terminal is applicable to the control switch 24 controlling wireless charging. In other words, the control signal from the CO terminal is simultaneously applied to both the charging control switch 41 and the control switch 24. Thus, wireless charging and wired charging of the battery cell 10 is simultaneously performed. When the battery cell 10 is overcharged, the charging operations of the wireless charging circuit 20 and the wired charging circuit 40 are simultaneously terminated.

FIG. 3 is a circuit diagram of the battery pack of FIG. 1, according to another embodiment of the present invention. The battery pack 1 of FIG. 3 has structures and operations similar to those of the battery pack 1 of FIG. 2, and thus only differences therebetween will now be described.

In the present embodiment, the current inducting circuit 21 includes the coil L2 and a plurality of capacitors C3 through C5. The coil L2 is inductively coupled to the coil L1 of the wireless charger 100, and detects a change in a magnetic field generated when an alternating current is supplied to the coil L1 to generate an induction current. The capacitors C3 through C5 are connected in series with each other between both terminals of the coil L2. With regards to the capacitances of the capacitors C3 through C5 and the inductance of the coil L2, a charging frequency is set to be a resonance frequency of the current inducting circuit 21.

A diode bridge circuit is used as the rectifier circuit 22. However, aspects of the present invention are not limited thereto, and other circuit configuration may be used as the rectifier circuit 22. The rectifier circuit 22 includes a plurality of diodes D5 through D8. Input terminals of the rectifier circuit 22 are connected to both terminals of the capacitor C4, respectively. In other words, a voltage induced across both the terminals of the capacitor C4 is used to charge the battery cell 10. Output terminals of the rectifier circuit 22 are connected to the protection circuit 23. In this regard, an output from a terminal between the diode D6 and the diode D8 always has a positive value, and an output from a terminal between the diode D5 and the diode D7 always has a negative value. In other words, current induced by the coil L2 is a sine wave type, and the output current of the rectifier circuit 22 is a full-wave rectified sine wave type.

The protection circuit 23 of the wireless charging circuit 20 includes the diode Da preventing a reverse flow of current and the control switch 24 controlling wireless charging. The diode Da is connected between the positive electrode of the battery cell 10 and the terminal between the diodes D6 and D8. The diode Da prevents a reverse flow of current from the battery cell 10 to the wireless charging circuit 20. In other words, a leakage of current during wired charging of the battery cell 10 by the wired charger 100 is prevented. In addition, the diode Da prevents a leakage of current from the battery cell 10 to the wireless charging circuit 20 when discharging of the battery cell 10 occurs.

The control switch 24 controlling wireless charging includes the FET1 and the D1. When the battery cell 10 is charged, the control switch 24 is in an on-state. The drain electrode of the FET1 is connected to the negative electrode of the battery cell 10, and the source electrode of the FET1 is connected to the terminal between the diodes D5 and D7.

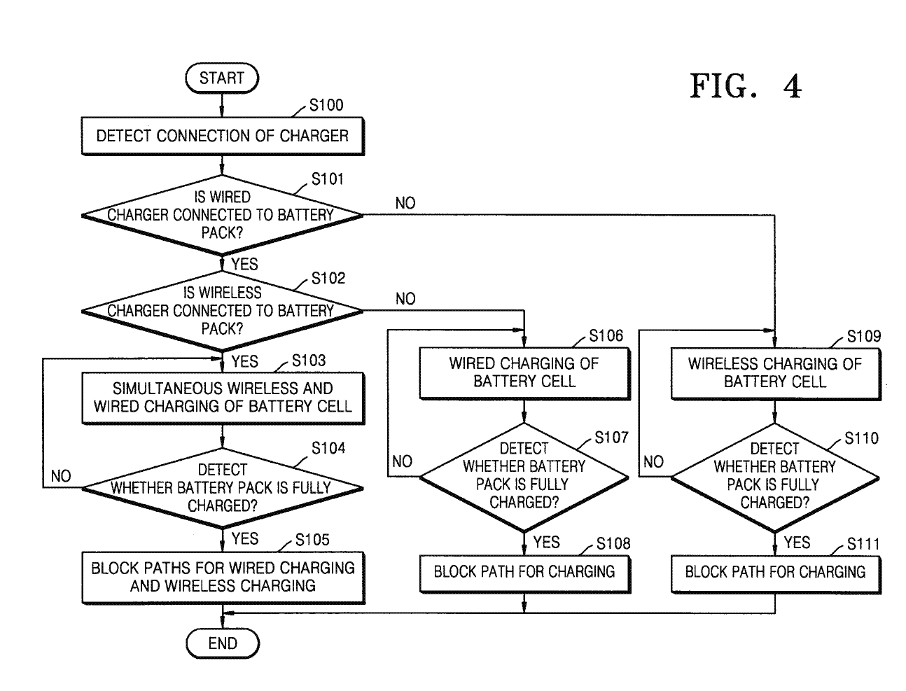

Hereinafter, a method of charging the battery pack 1 illustrated in FIGS. 2 and 3 will be described. FIG. 4 is a flowchart illustrating a method of controlling charging of a battery pack, according to an embodiment of the present invention. Referring to FIG. 4, the control circuit 50 detects whether the battery pack 1 is connected to a charger (operation S100). If the control circuit 50 detects that the charger is connected to the battery pack 1, the control circuit 50 determines whether the charger is a wired charger (operation S101).

If it is determined that the charger is a wired charger, it is determined whether a wireless charger is also connected to the battery pack 1 (operation S102). If it is determined that a wireless charger is also connected to the battery pack 1, the battery cell 10 is charged simultaneously in wired and wireless manners (operation S103). Next, it is determined whether the battery cell 10 is fully charged (operation S104). If the battery cell 10 is not fully charged, the operation goes back to the operation S103 and charging of the battery cell 10 continues. If the battery cell 10 is fully charged, both wired and wireless charging paths are blocked (operation S105) and charging of the battery cell 10 is terminated.

Meanwhile, in the operation S102, if it is determined that a wireless charger is not connected to the battery pack 1, the battery cell 10 is charged only through the wired charger (operation S106). Then, it is determined whether the battery cell 10 is fully charged (operation S107). If the battery cell 10 is not fully charged, the operation goes back to the operation S106 and charging of the battery cell 10 continues. If the battery cell 10 is fully charged, the wired charging path is blocked (operation S108) and charging of the battery cell 10 is terminated.

In addition, in the operation S101, if it is determined that the charger is not a wired charger, it is determined that a wireless charger is connected to the battery pack 1 and the battery cell 10 is charged through the wireless charger (operation S109). Then, it is determined whether the battery cell 10 is fully charged (operation S110). If the battery cell 10 is not fully charged, the operation goes back to the operation S109 and charging of the battery cell 10 continues. If the battery cell 10 is not fully charged, the wired charging path is blocked (operation S111) and charging of the battery cell 10 is terminated.

The operation S101 may be followed by the operation S102, or vice versa. Thus, according to another embodiment, it is first determined whether a wireless charger is connected to the battery pack 1, and then it may be determined whether a wired charger is connected thereto.

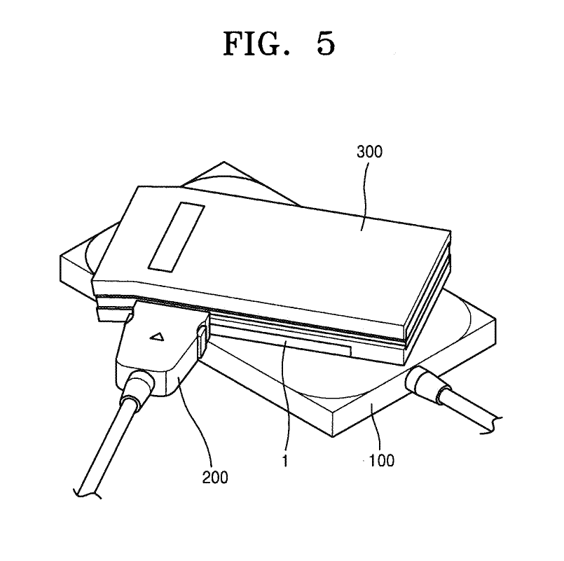

FIG. 5 is a concept view illustrating charging of the battery pack of FIG. 1. Referring to FIG. 5, a mobile phone equipped with the battery pack 1 is charged simultaneously with the wireless charger 100 and the wired charger 200. The wired charger 200 supplies power to the battery pack 1 via a connection terminal included in an electronic device, and the wireless charger 100 is inductively coupled to the battery pack 1, thereby supplying power to the battery pack 1. Although not illustrated in FIG. 5, the power transmitted by the wireless charger 100 may be received by using an antenna included in electronic devices, such as mobile phones, and the like.

As described above, according to the one or more of the above embodiments of the present invention, a battery pack is chargeable in a wireless or wired manner, or chargeable simultaneously in wireless and wired manners. In addition, a wireless charging circuit and a wired charging circuit include a switching element, whereby the battery pack may be stably operated in any charging manner.

A program for executing the charging methods according to one or more embodiments of the present invention in the battery pack may be stored in recording media. The term “recording media” used herein refers to processor readable media, and the recording media may be semiconductor recoding media, for example, flash memories. The recording media are readable by a processor, and may be executed in the processor.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A battery pack comprising:
a chargeable battery cell;
a first charging circuit wirelessly charging the battery cell;
a terminal part connecting the battery cell to an external device;
a second charging circuit charging the battery cell by using power from an external power source connected to the terminal part; and
a control circuit controlling charging performed by the first charging circuit and the second charging circuit.

2. The battery pack of claim 1, wherein the battery cell is simultaneously charged via the first charging circuit and the second charging circuit.

3. The battery pack of claim 1, wherein the first charging circuit comprises:
a current inducing circuit generating a current induced by an external magnetic field; and
a rectifier circuit rectifying the induced current.

4. The battery pack of claim 1, wherein the first charging circuit comprises a diode preventing a reverse flow of current from the battery cell.

5. The battery pack of claim 1, wherein the first charging circuit comprises a first control switch preventing over-charging of the battery cell.

6. The battery pack of claim 5, wherein the second charging circuit comprises a second control switch controlling charging of the battery cell.

7. The battery pack of claim 6, wherein the control circuit applies control signals to the first control switch and to the second control switch, wherein the control signals are the same.

8. The battery pack of claim 1, wherein the first charging circuit induces a current from a signal having a frequency of 13.56 MHz.

9. The battery pack of claim 1, wherein an antenna installed in the external device is shared with the first charging circuit.

10. A method of controlling charging of a battery pack having a chargeable battery cell and a terminal part connected in parallel to the battery cell, the method comprising:
wirelessly charging the battery cell by using power induced by an external magnetic field; and
charging the battery cell via a wired connection by using an external power source applied to the terminal part.

11. The method of claim 10, wherein the wireless charging and the wired charging are simultaneously performed.

12. The method of claim 10, wherein, when only the wired charging is performed, a reverse flow of current from the battery cell to an element for the wireless charging is prevented.

13. The method of claim 10, wherein, when the battery cell is over-charged, the wired charging and the wireless charging of the battery cell are simultaneously terminated.

14. The method of claim 10, wherein the wireless charging of the battery cell comprises:
inducing a current via an external magnetic field;
rectifying the induced current;
and charging the battery cell by using the rectified current.

15. The method of claim 10, wherein, in the wireless charging of the battery cell, a signal having a frequency of 13.56 MHz is used.

16. A method of charging a battery pack having a rechargeable battery cell, a wireless charger, a wired charger and a terminal part connected in parallel to the battery cell, the method comprising:
determining whether the wired charger is connected to the battery pack;
determining whether the wireless charger is connected to the battery pack;
charging the battery cell of the battery pack according to the determining whether the wired charger is connected to the battery pack and the determining whether the wireless charging is connected to the battery pack;
determining whether the battery cell of the battery pack is fully charged; and
terminating the charging upon the determining that the battery pack is fully charged.

17. The method of claim 16, wherein the charging of the battery cell comprises charging the battery cell using the wired charger and the wireless charger simultaneously if it is determined that the wired charger and the wireless charger are connected to the battery pack.

18. The method of claim 16, wherein the charging of the battery cell comprises:
charging the battery cell using only the wired charger if it is determined that only the wired charger is connected to the battery pack; and
blocking a reverse flow of current from the battery cell to an element for the wireless charging.

19. The method of claim 16, wherein the charging of the battery cell comprises charging the battery cell using only the wireless charger if it is determined that only the wireless charger is connected to the battery pack.

20. The method of claim 16, wherein if the charging of the battery cell includes a wireless charging of the battery cell using the wireless charger, the wireless charging comprises:
inducing a current via an external magnetic field;
rectifying the induced current; and
charging the battery cell by using the rectified current.
